(19) United States
(12) Patent Application Publication
(10) Pub. No.: US 2009/0231600 A1
(43) Pub. Date: Sep. 17, 2009

(54) IMAGE FORMING APPARATUS, CONTROL METHOD OF IMAGE FORMING APPARATUS, CONTROL PROGRAM OF IMAGE FORMING APPARATUS, AND PRINT MEDIUM

(75) Inventor: Kiyoshi Hashimoto, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/402,253

(22) Filed: Mar. 11, 2009

(30) Foreign Application Priority Data
Mar. 11, 2008 (JP) 2008-061593

(51) Int. Cl. G06K 1/00

(52) U.S. Cl. 358/1.5; 340/572.1

(57) ABSTRACT

When a wireless IC tag in which information on a print area of a medium is recorded is provided in the medium, an image forming apparatus which forms an image on the medium by inputting the image includes: a wireless IC tag reader which reads information recorded in the wireless IC tag; an information acquiring unit which acquires the information from the wireless IC tag by using the wireless IC tag reader; a tag actual location designating unit which designates an actual location of the wireless IC tag by using the wireless IC tag reader; a reference location designating unit which designates a reference location of the medium; an angle calculating unit which calculates a rotational angle used to set the designated actual location of the wireless IC tag to a predetermined location on the basis of the designated reference location of the medium; and an image forming unit which forms the image in the print area of the medium by rotating the image by the calculated rotational angle.

### BACKGROUND

1. Technical Field

The present invention relates to an image forming apparatus, a control method of the image forming apparatus, a control program of the image forming apparatus, and a print medium, and particularly relates to a technique for appropriately forming an image in a print area of the print medium.

2. Related Art

A non-contact wireless IC tag (non-contact IC tag) such as an NFC (Near Field Communication) tag, which is a representative example of an RFID (Radio Frequency-IDentification) tag is well known. The non-contact wireless IC tag includes a small IC chip and a chip antenna and is capable of electrically recording or reading electronic data stored in the IC chip by obtaining electric power by electromagnetic induction. The wireless IC tag which stores various kinds of electronic data in the small IC chip can read or record the electric data by use of radio waves or electromagnetic waves. Accordingly, it is possible to employ the recorded electronic data by attaching or embedding the wireless IC tag to or in various devices (hereinafter, even though only the sentence that the wireless IC tag is attached is used, it is assumed that the sentence that the wireless IC tag is embedded is implied) to record electronic data in the wireless IC tag.

A technique for detecting the location of the wireless IC tag is also well known. For example, JP-A-2004-132890 discloses a non-contact IC card reader/writer in which the location of a non-contact IC card is calculated on the basis of a distribution of the locations of plural antennas replied from the non-contact IC card by sequentially driving the plural antennas arranged in a matrix shape on the same plane or in which the location of the non-contact IC card is calculated on the basis of voltage levels of carrier waves received from the non-contact IC card by the plural antennas and the locations of the antennas receiving the carrier waves by simultaneously driving the plural antennas arranged in the matrix shape on the same plane.

On the other hand, JP-A-2003-1873 and JP-A-2004-358714 disclose a printing apparatus capable of printing a read image on a label surface of a medium (for example, a CD-R).

The medium to be subjected to the label printing process is assumed to be a disk generally having a diameter of 12 cm. When the surface of the disk on which an image is not printed is a print area, a proper printing process is possible in a state where a print target is set to a guide of a disk tray, since a restriction on directions of the print target such as vertical, horizontal, upper, lower, right, and left directions is not imposed.

However, there is a disk having a small diameter of 8 cm, for example, as well as the disk having the diameter of 12 cm. Therefore, a flexibility of the disk size is not permitted, when the medium in which the label printing process is possible is restricted to the disk having the diameter of 12 cm. In order to solve this problem, a method of performing the label printing process by setting a panel of a printer to make the disk size appropriate can be taken into consideration. However, this method is also troublesome for a user and there is a possibility that an image for the disk having the diameter of 12 cm is printed on a label surface of the disk having the diameter of 8 cm, thereby causing the disk tray to be unclean.

When the surface of a disk on which an image is not printed is set as a print area, it is not necessary to mind location match (rotational angle) in a circumferential direction upon setting the disk to the disk tray. However, when the print area is restricted, for example, when a medium has a different shape or a print area is defined due to a presence of an area which is not desirable for a printing process even in the circular medium, a problem may occur in that ink comes out from the medium and the disk tray thus becomes dirty unless the location match is exactly made, or a problem may occur in that an image is printed on the area which is not desirable for a printing process.

### SUMMARY

An advantage of some aspects of the invention is that it provides an image forming apparatus capable of forming an image in a print area of a medium to be set (placed) without minding location match of the medium, a control method of the image forming apparatus, a control program of the image forming apparatus, and a print medium.

According to an aspect of the invention, there is provided an image forming apparatus which forms an image on a medium by inputting the image and includes a wireless IC tag reader, an information acquiring unit, a tag actual location designating unit, a reference location designating unit, an angle calculating unit, and an image forming unit, when a wireless IC tag in which information on a print area of the medium is recorded is provided in the medium.

The wireless IC tag reader reads information recorded in a wireless IC tag. The information acquiring unit acquires the information from the wireless IC tag by using the wireless IC tag reader. The tag actual location designating unit designates an actual location of the wireless IC tag by using the wireless IC tag reader. The reference location designating unit designates a reference location of the medium. The angle calculating unit calculates a rotational angle used to set the designated actual location of the wireless IC tag to a predetermined location on the basis of the designated reference location of the medium. The image forming unit forms the image in the print area of the medium by rotating the image by the calculated rotational angle.

With such a configuration, it is possible to form the image in the print area of the medium without minding location match of the medium even in the medium in which the print area is restricted. That is, even when the rotational angle of the medium is not adjusted upon setting (placing) the medium, a panel is not set so as to match with the size of the medium, or the print area is not set, the image is formed without ink coming out from the medium or the image is formed without printing the image in a non-preferable area.

Here, the problem that the ink comes out from the print area of the medium in the printing process occurs due to a difference caused by the input image, the location of the print area of the placed medium, and the angle. Therefore, as long as the input image can be formed in the print area of the medium without forming the image out of the print area by rotation which is based on a relation between the designated actual location and the designated reference location of the medium. For example, in the medium having a round hole, the center of the round hole or a predetermined location appropriately away from the center of the round hole can be set as the reference location.

In the image forming apparatus, the angle calculating unit may convert the designated actual location of the wireless IC tag into a coordinate using the designated reference location as the origin and calculates a rotational angle used to set the coordinate to a predetermined coordinate using the reference location of the medium as the origin and being based on the predetermined location. With such a configuration, the rotational angle is appropriately calculated.

In the image forming apparatus, the predetermined location may be a predefined location where the wireless IC tag is attached to or embedded in the medium. With such a configuration, the rotational angle is simply calculated.

In the image forming apparatus, information on an attachment location where the wireless IC tag is attached to or embedded in the medium may be additionally recorded in the wireless IC tag. In addition, the predetermined location may be a coordinate using the reference location of the medium as the origin and being based on the attachment location. With such a configuration, the rotational angle is simply calculated.

In the image forming apparatus, the attachment location may be present on one of coordinate axes in a rectangular coordinate system using the reference location of the medium as the origin. With such a configuration, the rotational angle is more simply calculated.

In the image forming apparatus, the wireless IC tag reader may be equipped in a print head forming the image. The medium may be set to a media tray which is moved in a sheet feeding direction perpendicular to a scanning direction of the print head. In addition, the tag actual location designating unit may designate the actual location of the wireless IC tag by sequentially moving the media tray whenever the print head performs scanning and scanning the wireless IC tag reader on the entire surface of the medium. With such a configuration, it is possible to appropriately designate the actual location of the wireless IC tag, even when the wireless IC tag readers are not disposed in a matrix shape on the same surface so as to cover the entire surface of the medium, that is, fewer wireless IC tag readers are provided, for example. Moreover, it is possible to use a known configuration of, for example, a well-known printer which includes a print head and a media tray and can perform a label printing process.

The image forming apparatus may further include a print area storage unit which stores an area where the image is formed beforehand. With such a configuration, since the print area of the medium can be updated into a new print area other than the area where the image is formed beforehand, it is possible to additionally form an image without overlapping with the area where the image is formed beforehand in an appropriate manner.

In the image forming apparatus, the wireless IC tag reader may be a wireless IC tag reader/writer which also records information in the wireless IC tag. In addition, the print area storage unit may record information on the area where the image is formed beforehand in the wireless IC tag. With such a configuration, the print area of the medium is simply updated into the new print area.

In the image forming apparatus, the print area storage unit may store the information on the area where the image is formed beforehand in association with medium identification information for designating the medium in a predetermined storage unit. With such a configuration, the print area of the medium is simply updated into the new print area.

The technical spirit of the invention is understandable as aspects of the invention other than the image forming apparatus described above. For example, the aspect of the invention is understandable as a control method of the image forming apparatus including steps corresponding to the units of the image forming apparatus described above.

The aspect of the invention is understandable as a control program of the image forming apparatus causing a computer to execute functions corresponding to the units of the image forming apparatus described above. Moreover, the aspect of the invention is understandable only with a print medium applicable to the image forming apparatus described above.

### BRIEF DESCRIPTION OF THE DRAWINGS

The invention will be described with reference to the accompanying drawings, wherein like numbers reference like elements.

FIG. 1 is a diagram illustrating the appearance of a printing apparatus and the appearance of a CD/DVD medium.

FIG. 2 is a block diagram illustrating the configurations of the printing apparatus and the CD/DVD medium.

FIGS. 3A to 3D are diagrams illustrating the appearances of various CD/DVD media according to the invention.

FIG. 4 is an explanatory diagram illustrating a method of detecting an actual location of an NFC tag.

FIGS. 5A and 5B are explanatory diagrams illustrating a method of calculating a rotational angle of the CD/DVD medium.

FIGS. 6A and 6B are explanatory diagrams illustrating coordinate change of a print image in accordance with the rotational angle.

FIG. 7 is a flowchart illustrating calculation of the rotational angle which is performed by a control unit.

FIG. 8 is a flowchart illustrating a coordinate change process on the print image which is performed by the control unit.

### DESCRIPTION OF EXEMPLARY EMBODIMENTS

Hereinafter, an embodiment of the invention will be described with reference to the drawings in the following order:

1. Overall Configuration of Image Forming Apparatus and Print Medium,

2. Method of Detecting Location of NFC Tag on Medium,

3. Method of Calculating Rotational Angle of Medium Based on Actual Location of NFC Tag,

4. Method of Performing Coordinate Change in Print Image in Accordance with Rotational Angle,

5. Operation of Image Forming Apparatus in Label Printing Process, and

6. Summary.

### 1. Overall Configuration of Image Forming Apparatus and Print Medium

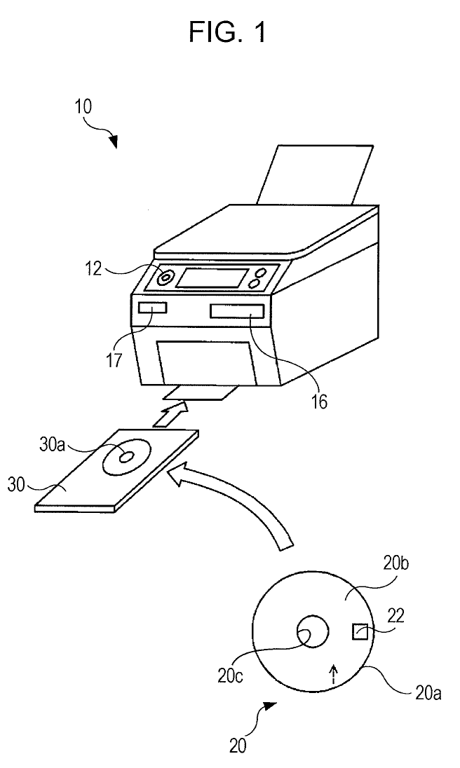

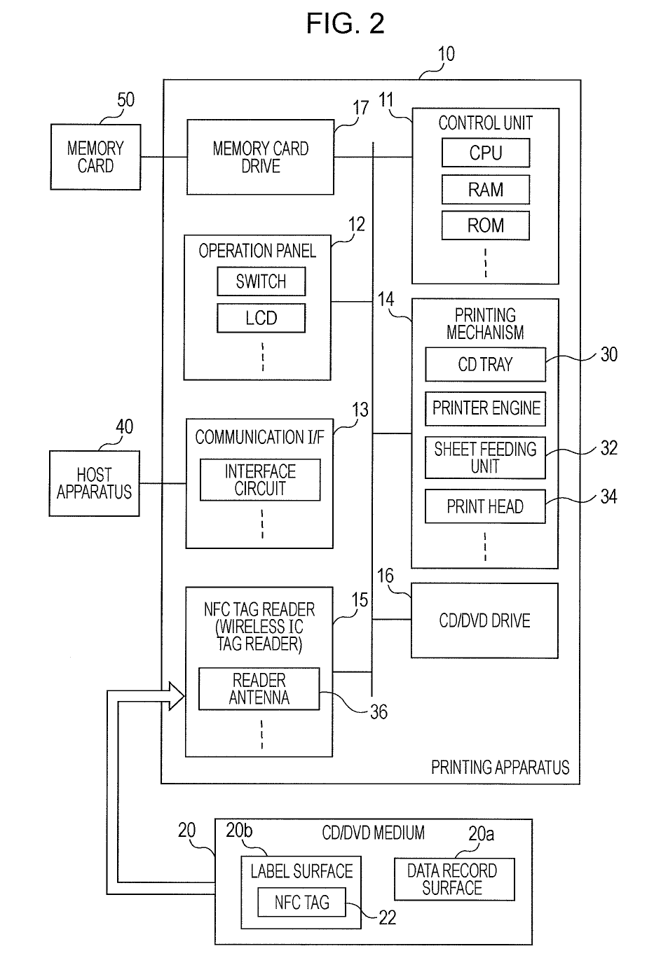

FIG. 1 is a diagram illustrating the appearance of a printing apparatus 10 as an image forming apparatus and the appearance of a CD/DVD medium 20 as a print medium according to the embodiment of the invention. FIG. 2 is a block diagram illustrating the configurations of the printing apparatus 10 and the CD/DVD medium 20.

In FIGS. 1 and 2, the CD/DVD medium 20 includes a data record surface 20a on which electronic data (file) can be recorded, a label surface 20b which is a rear surface of the data record surface 20a and on which an image can be printed by the printing apparatus 10, a round hole 20c as a fixing hole into which a protrusion 30a of a CD tray 30 as a media tray or a protrusion of a predetermined CD case (not shown) is inserted when the CD/DVD medium 20 is set to the CD tray 30 or fixed to the predetermined CD case (not shown), and a wireless IC tag 22 which is attached to the label surface 20b. The CD/DVD medium 20 is an example of a well-known CD-R, a CD-RW, a DVD-R, or a DVD-RW used when electronic data stored in a memory card 50 or the like are backed up. In particular, the CD/DVD medium 20 includes the wireless IC tag 22.

The wireless IC tag 22 is a non-contact wireless IC tag such as an RFID tag which includes a small IC chip and a chip antenna and is capable of obtaining electronic power by electromagnetic induction and electronically recording or reading electronic data in or from the IC chip. In this embodiment, a well-known NFC tag (hereinafter, the wireless IC tag 22 is referred to as an NFC tag 22) is used. In particular, in this embodiment, information on a print area (which is also referred to as a print range, a printable area, or the like) of the CD/DVD medium 20 necessary upon performing a label printing process is stored in the NFC tag 22.

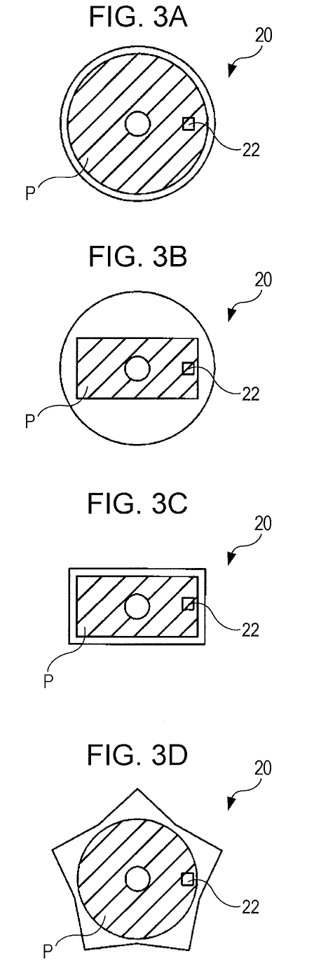

FIGS. 3A to 3D are diagrams illustrating the appearances of various CD/DVD media 20 according to the invention. In FIGS. 3A to 3D, each of portions shown by oblique lines indicates a print area and the NFC tag 22 in which information on the print area is recorded is attached to a predetermined location. FIG. 3A shows a well-known circular medium on which a general print area P is set. FIG. 3B shows a circular medium on which a print area P is set to be more restrictive than a general print area. FIGS. 3C and 3D show media which each have a different shape and thus each have a print area P which is more restrictive than a general print area.

In this embodiment, as described below, the NFC tag 22 is attached to the CD/DVD medium 20 recording information on the print area and a label printing process is performed by using the information on the print area, in order to appropriately print an image on the label surface of the CD/DVD medium 20 without a case of an image is printed outside the print area P or without a case where a relative location with the CD/DVD medium 20 is different, even when a user does not set the print area P in every label printing.

However, as apparent from FIGS. 3A to 3D, when the CD/DVD media 20 other than the CD/DVD medium 20 shown in FIG. 3A are not properly set in the CD tray 30 upon performing the label printing process, that is, the CD/DVD media 20 are set upon rotating the CD/DVD media 20, there is a possibility that an image is not appropriately printed on the CD/DVD media 20 only with the information on the print area. In order to solve this problem, in this embodiment, it is configured that an image is appropriately printed on the label surface of the CD/DVD media 20 without minding setting of the CD/DVD media 20 to the CD tray 30.

The predetermined location is a predetermined location where the NFC tag 22 is attached to the CD/DVD medium 20. That is, the NFC tag 22 is not attached to an arbitrary location, but attached to the predetermined location. Accordingly, the location to which the NFC tag 22 is attached can be grasped, when information on the location to which the NFC tag 22 is attached is necessary, even in a case where the information on the location is not recorded in the NFC tag 22.

The printing apparatus 10 includes a control unit 11, an operation panel 12, a communication I/F 13, a print mechanism 14, an NFC tag reader 15 as a wireless IC tag reader, a CD/DVD drive 16, and a memory card drive 17. The printing apparatus 10 performs a printing process by receiving a control instruction from a printer driver installed in a host apparatus 40 or the like. For example, the printing apparatus 10 is capable of performing a label printing process of forming an image input from the host apparatus 40 on the label surface 20b of the CD/DVD medium 20 set through the round hole 20c.

Moreover, the printing apparatus 10 is also a so-called direct printer which directly prints (including the label printing process) an image based on electronic data of the CD/DVD medium 20 read by the CD/DVD drive 16 or an image based on electronic data of the memory card 50 read by the memory card drive 17 without the host apparatus 40, by inserting the CD/DVD medium 20 into the CD/DVD drive 16 or inserting the memory card 50 into the memory card drive 17.

The control unit 11 which include a CPU, a RAM, a ROM, a memory controller, and a non-volatile RAM is a unit which performs a process of allowing the print mechanism 14 to generate a print of contents according to print work data received from the host apparatus 40 and a process of transmitting status information indicating statuses (a usable function, an amount of a remaining consumption supply, and the like) of the printing apparatus 10 to an apparatus requesting the statuses information.

The CPU controls the units of the control unit 11 on the whole in accordance with programs stored in the ROM or the like. The RAM is a memory which temporarily stores the print work data received through the communication I/F 13 or the like and data generated on the basis of the print work data by the CPU. The ROM is a non-volatile memory in which various programs to be loaded to the RAM and executed by the CPU are stored in a compressed state. The memory controller performs a process of transmitting data from the communication I/F 13 or the like to the RAM in accordance with an instruction of the CPU or a process of transmitting data from the RAM to the printer engine of the print mechanism 14. The non-volatile RAM, which is a unit storing various kinds of information that has to be stored even when power is turned off, is a rewritable non-volatile memory (for example, an EEPROM or an NVRAM) equipped in the printing apparatus 10 (the control unit 11).

The operation panel 12 is a user interface unit between the user and the printing apparatus 10 (the control unit 11). The operation panel 12 is a unit which includes plural press button switches for receiving operations of the user and an LCD (Liquid Crystal Display) for displaying various messages indicating the statuses of the printing apparatus 10. Here, the operations of the user refer to a process of instructing a print layout, a process of selecting image data of a print target, a label printing process in the CD/DVD medium 20, and the like.

The communication I/F 13 which has at least one of interface circuits corresponding to various communication units such as the Bluetooth, the IrDA, wired/wireless LANs, and a USB is an interface for carrying out predetermined communication (information exchange) with the host apparatus 40, for example.

The print mechanism 14 which includes the CD tray 30, a sheet feeding unit 32, a print head 34, and the printer engine is a mechanism which actually performs a printing process on a fed sheet or the label printing process on the label surface 20b of the CD/DVD medium 20 set to the CD tray 30.

Upon performing the label printing process, the CD/DVD medium 20 is set to the protrusion 30a of the CD tray 30 through round hole 20c and the CD tray 30 is mounted on a main body of the printing apparatus 10 so as to be moved in a sheet feeding direction (sub-scanning direction) perpendicular to a scanning direction (main scanning direction) of the print head 34 by the sheet feeding unit 32.

The NFC tag reader 15 includes a reading antenna 36 for reading information from the IC chip by carrying out wireless communication with the chip antenna of the NFC tag 22 and can read information stored in the NFC tag 22 by carrying out wireless communication in accordance with an instruction of the control unit 11, for example. The NFC tag reader 15 is equipped in the print head 34 so that at least the reading antenna 36 is moved together with the print head 34 in the main scanning direction, and can carry out wireless communication with the NFC tag 22 of the CD/DVD medium 20 set to the CD tray 30.

The CD/DVD drive 16 can read, delete, and rewrite the electronic data stored on the data record surface 20a of the CD/DVD medium 20, and can newly record electronic data on the data record surface 20a in accordance with an instruction of the control unit 11, for example.

The memory card drive 17 can receive and store the electronic data stored in the memory card 50. Moreover, in accordance with an instruction of the control unit 11, the memory card drive 17 can delete and rewrite the electronic data stored in the memory card 50 and can newly record electronic data in the memory card 50.

The host apparatus 40 is a personal computer or the like in which a printing apparatus controlling program and a utility program developed for the printing apparatus 10 are installed in a computer (which is a computer in which an OS, a Web browser, and the like are installed) having a general configuration connected to the printing apparatus 10. The printing apparatus controlling program is a program (a so-called printer driver) which generated print work data to be supplied to the printing apparatus 10 on the basis of data on a print target document sent from an application program (and the OS). In addition, the utility program is a program which provides the user of the host apparatus 40 with an environment of simply using reserve work data (which are mainly stored by the user) stored in the printing apparatus 10.

In the printing apparatus 10 having the configuration described above, the control unit 11 functionally includes an information acquiring unit which acquires information from the NFC tag 22 by using the NFC tag reader 15, a tag actual location designating unit which designates an actual location of the NFC tag 22 by using the NFC tag reader 15, a reference location designating unit which designates a reference location of the CD/DVD medium 20, an angle calculating unit which calculates a rotational angle used to set the actual location of the NFC tag 22 designated on the basis of the reference location of the designated CD/DVD medium 20 as a predetermined location, and an image forming unit which forms an image in the print area P of the CD/DVD medium 20 by rotating the image input on the basis of the calculated rotational angle.

### 2. Method of Detecting Location of NFC Tag on Medium

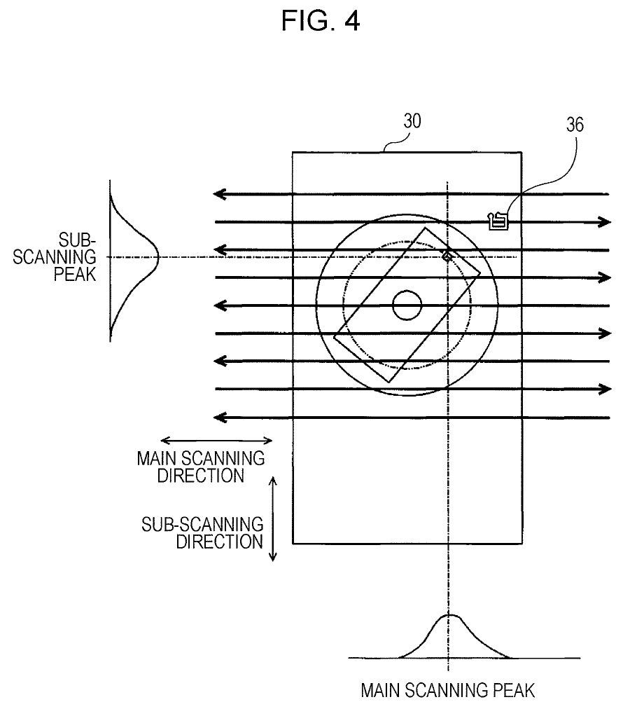

FIG. 4 is an explanatory diagram illustrating a method of detecting the location of the NFC tag 22 of the CD/DVD medium 20 set to the CD tray 30. In FIG. 4, the control unit 11 of the printing apparatus 10 allows the print head 34 to perform scanning in the main scanning direction and allows the sheet feeding unit 32 to sequentially move the CD tray 30 in the sub-scanning direction in every scanning. Then, the control unit 11 allows the reading antenna 36 of the NFC tag reader 15 to scan the entire surface of the CD/DVD medium 20 (the tag actual location designating unit and the information acquiring unit). At this time, the control unit 11 requests information to the NFC tag 22 by sending an electric field from the reading antenna 36 and receives a reply (information transmission) from the NFC tag 22 (the information acquiring unit). In addition, the control unit 11 performs detection in association with voltage levels (voltage of reception waves of the reading antenna 36) of the carrier waves received from the NFC tag 22 and a coordinate value on the CD tray 30. The coordinate value on the CD tray 30 can be designated by a driving mechanism of the print head 34 and a driving mechanism of the sheet feeding unit 32. A coordinate in which both the main scanning direction and the sub-scanning direction become peak voltage is set to the actual location of the NFC tag 22 (the tag actual location designating unit).

### 3. Method of Calculating Rotational Angle of Medium Based on Actual Location of NFC Tag

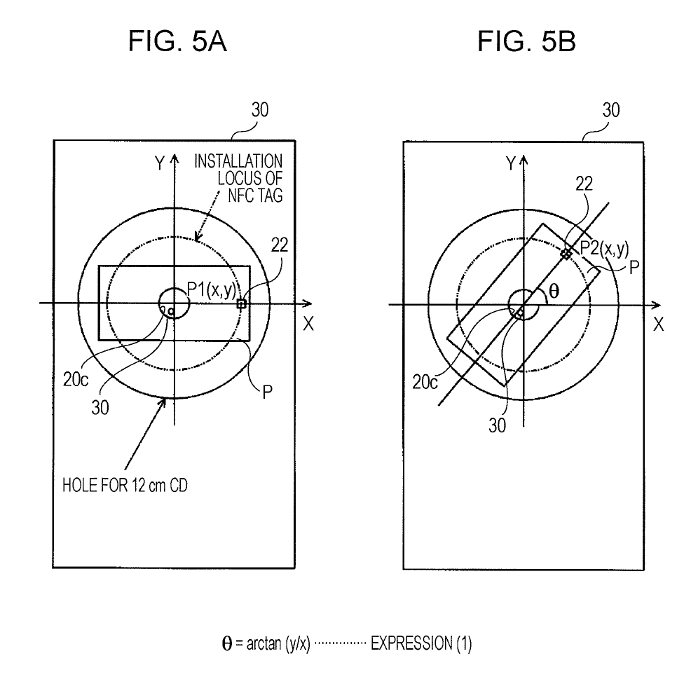

FIGS. 5A and 5B are explanatory diagrams illustrating a method of calculating the rotational angle of the CD/DVD medium 20 set to the CD tray 30. FIG. 5A shows that a circular medium in which a print area is restricted or a medium having a different shape is set when the NFC tag 22 is located at the predetermined location in a non-rotation state. FIG. 5B shows that the medium is set when the medium is rotated by a rotational angle θ. In FIGS. 5A and 5B, the control unit 11 of the printing apparatus 10 designates, for example, the center of the protrusion 30a of the CD tray 30, that is, the center of the round hole 20c of the CD/DVD medium 20 as a reference location of the CD/DVD medium 20 (the reference location designating unit). For example, the center of the protrusion 30a is stored as the coordinate on the CD tray 30 in the non-volatile RAM of the control unit 11 and read from the non-volatile RAM, for example. When it is assumed that the scanning direction of the print head 34 is an X axis and the sheet feeding direction is a Y axis, the designated actual location of the NFC tag 22 is changed into a coordinate P2 (x, y) using the designated reference location as the origin. The rotational angle θ used to change the actual location coordinate P2 (x, y) into a predetermined coordinate P1 (x, y) using the reference location as the origin and being based on a predetermined location is calculated (the angle calculating unit). For example, in FIGS. 5A and 5B, when the predetermined coordinate P1 (x, y) of the NFC tag 22 is on the x axis, the rotational angle θ of the CD/DVD medium 20 is presented by Expression (1) of FIGS. 5A and 5B by use of the actual location coordinate P2 (x, y).

4. Method of Performing Coordinate Change in Print Image in Accordance with Rotational Angle

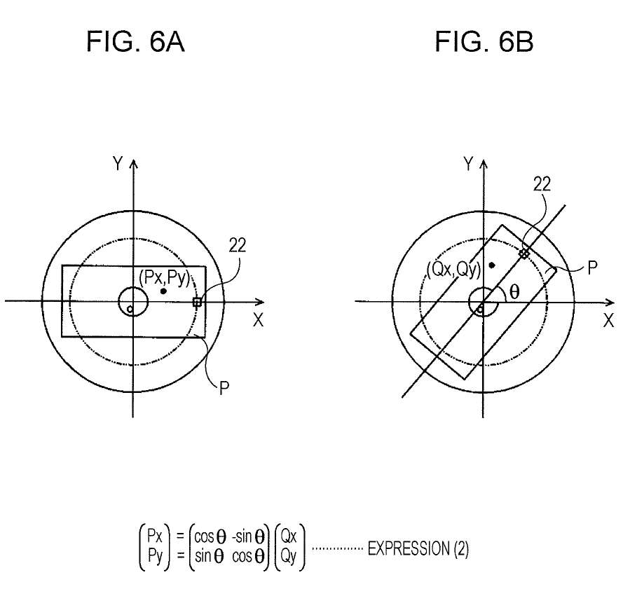

FIGS. 6A and 6B are explanatory diagrams illustrating coordinate change of a print image in accordance with the rotational angle of the CD/DVD medium 20 set to the CD tray 30. Likewise with FIGS. 5A and 5B, FIG. 6A shows that a medium is set in a non-rotation state and FIG. 6B shows that the medium is set in a rotation state where the medium is rotated by a rotational angle θ.

Here, information on the print area stored in the NFC tag 22 represents a coordinate in the non-rotation state of the CD/DVD medium 20 shown in FIG. 6A. Accordingly, in order to appropriately print an image on the label surface of the CD/DVD medium 20 set in the rotation state shown in FIG. 6B, a print image rotated by the rotational angle θ needs to be generated. When the print image is rotated, a process of changing coordinates of pixels forming the print image is necessary. For example, in FIGS. 6A and 6B, it is assumed that a coordinate of a pixel before the coordinate change is (Px, Py) and a coordinate obtained by rotating the coordinate by the rotational angle θ is (Qx, Qy), Expression (2) shown in FIGS. 6A and 6B is satisfied. Accordingly, the control unit 11 of the printing apparatus 10 can process the coordinate change by using the rotational angle θ calculated in Expression (1) shown in FIGS. 5A and 5B (the image forming unit).

### 5. Operation of Image Forming Apparatus in Label Printing Process

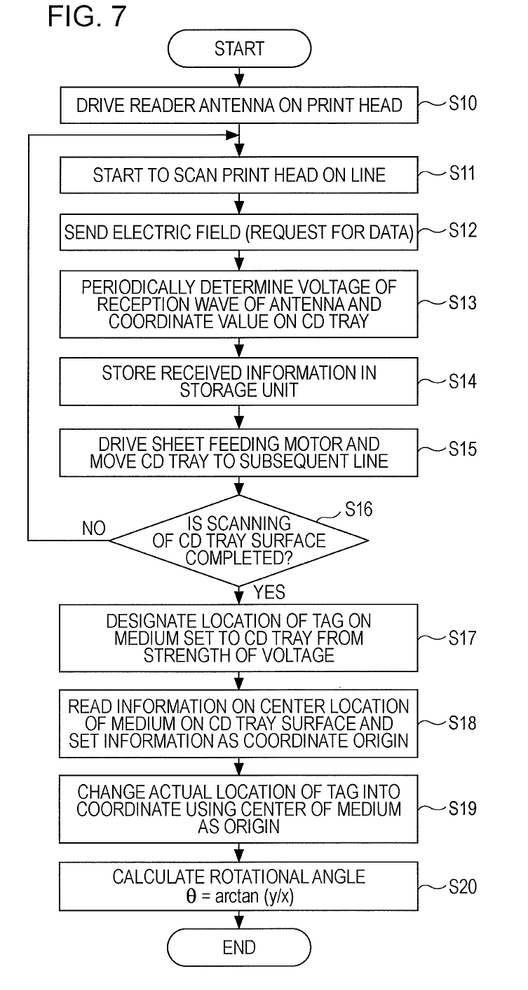

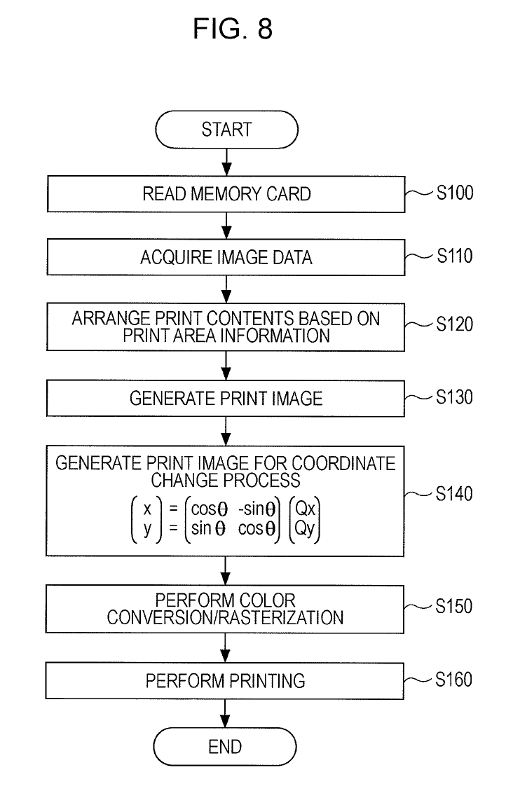

FIG. 7 is a flowchart illustrating a control process of calculating the rotational angle θ by designating the actual location of the NFC tag 22 during a control process of the label printing process performed in accordance with a predetermined program stored in the ROM, for example, by the control unit 11 of the printing apparatus 10. FIG. 8 is a flowchart illustrating a control process of generating the print data to perform the printing process during the label printing process performed in accordance with the predetermined program stored in the ROM, for example, by the control unit 11 of the printing apparatus 10.

In FIG. 7, in Step S10 (hereinafter, description of Step is omitted), the reading antenna 36 equipped in the print head 34 is driven. Subsequently, in S11, the print head 34 is scanned on the corresponding line (in the main scanning direction). Subsequently, in S12, the electric field is sent from the reading antenna 36 and information (for example, information on the print area) is requested to the NFC tag 22. At this time, when the NFC tag 22 is present near the reading antenna 36, the NFC tag 22 is replied and the information is thus transmitted. Subsequently, in S13, the voltage of the reception waves of the reading antenna 36 received from the NFC tag 22 and the coordinate value on the CD tray 30 are detected. Subsequently, in S14, the received information is stored in a storage unit such as the nonvolatile RAM of the control unit 11. Subsequently, in S15, the CD tray 30 is moved to a subsequent line by the sheet feeding unit 32. Subsequently, in S16, it is determined whether the entire surface of the CD/DVD medium 20 is scanned by the reading antenna 36 of the NFC tag reader 15. When the entire surface of the CD/DVD medium 20 is not scanned and the determination of S16 is thus NO, S11 and the steps subsequent to S11 are repeatedly performed.

Alternatively, when the entire surface of the CD/DVD medium 20 is completely scanned and the determination of S16 is thus YES, the actual location of the NFC tag 22 of the CD/DVD medium 20 set to the CD tray 30 is designated from the strength of the voltage of the reception waves of the reading antenna 36 in S17. That is, the coordinate in which the main scanning direction and the sub-scanning direction both become the peak voltage is determined as the actual location of the NFC tag 22. Subsequently, in S18, the center of the round hole 20c of the CD/DVD medium 20, that is, center information of the protrusion 30a is read as the reference location from the non-volatile RAM of the control unit 11 and the reference location is set as the coordinate origin. Subsequently, in S19, the actual location of the NFC tag 22 is changed into the coordinate P2 (x, y) using the reference location of the CD/DVD medium 20 as the origin. Subsequently, in S20, the rotational angle θ is calculated by Expression (1) of FIGS. 5A and 5B by using the coordinate P2 (x, y) of the actual location.

In FIG. 8, when the memory card 50 storing the image data, for example, is inserted into the memory card drive 17 and the memory card 50 is recognized in S100, the image data is acquired from the memory card 50 in S110. Subsequently, in S120, print contents are arranged so as to be inside the print area on the basis of the information on the print area stored in the non-volatile RAM in S14 of FIG. 7. Subsequently, in S130, the print image is generated. Subsequently, in S140, the print image generated in S130 by Expression (2) of FIGS. 6A and 6B is subjected to the coordinate change to be rotated by the rotational angle θ calculated in S20 of FIG. 7. Subsequently, in S150, the print image subjected to the coordinate change is subjected to the color conversion and rasterization. In S160, the label printing process is performed in the CD/DVD medium 20.

### 6. Summary

The printing apparatus 10 having the above-described configuration is capable of forming an image in the print area P of a medium (for example, the CD/DVD medium 20) without minding the location match of the medium even in the medium of which the print area P is restricted. That is, even though a rotational angle of the medium is not adjusted upon setting the medium to the CD tray 30, a panel operation of setting the size of the medium is not performed, or the print area P is not set, an image is formed without ink coming out from the medium or an image is formed without printing the image in a non-preferable area.

The designated actual location of the NFC tag 22 is changed into the coordinate using the designated reference location of the medium as the origin and the rotational angle θ used to set the coordinate to a predetermined coordinate using the reference location of the medium as the origin and being based on the predetermined location is calculated. Accordingly, the appropriate rotational angle θ is calculated.

Since the predetermined location is a predefined location in which the NFC tag 22 is attached to the medium, the rotational angle θ is simply calculated. Moreover, it is not necessary to store the information on the attachment location of the NFC tag 22 in the NFC tag 22.

The NFC tag reader 15 is equipped in the print head 34 forming an image, the medium is set to the CD tray 30 which can be moved in the sheet feeding direction perpendicular to the scanning direction of the print head 34, and the actual location of the NFC tag 22 is designated by sequentially moving the CD tray 30 whenever the print head 34 performs scanning and by scanning the NFC tag reader 15 on the entire surface of the medium. Accordingly, even when the NFC tag readers 15 are not disposed in a matrix shape on the same plane so as to cover the entire surface of the medium, for example, that is, even when fewer NFC tag readers 15 are provided, the actual location of the NFC tag 22 can be appropriately designated. Moreover, the configuration in which the print head 34 and the CD tray 30, for example, are provided, the known configuration of a well-known printer capable of performing label printing can be appropriately used.

The embodiment of the invention has been described in detail with reference the drawings, but the invention is also applied to other forms.

For example, in the embodiment described above, the predetermined location is the predefined location in which the NFC tag 22 is attached to the CD/DVD medium 20. However, the information on the attachment location of the NFC tag 22 to the medium may be additionally recorded in the NFC tag 22 and the NFC tag 22 may be attached to an arbitrary location of the CD/DVD medium 20. In this case, the predetermined location is the coordinate using the reference location of the medium as the origin and being based on the attachment location. Even with such a configuration, the rotational angle is simply calculated. In particular, the attachment location may be set on one, for example, the X axis or the Y axis of the coordinate in a rectangular coordinate system using the reference location of the attachment location as the origin. In this way, the rotational angle is more simply calculated.

In the embodiment described above, the control unit 11 of the printing apparatus 10 may further functionally include a print area storage unit which stores an area where an image is formed beforehand, that is, an area where a print image of an image is generated in a non-rotation state of the medium in the non-volatile RAM of the control unit 11. With such a configuration, since the print area of the medium can be updated into a new print area other than the area where an image is formed beforehand, it is possible to additionally print an image without overlapping with the area in which the image is printed beforehand. Moreover, even when the printing process is interrupted, the interrupted printing process can additionally continue.

Specifically, the NFC tag reader 15 may be configured as a wireless IC tag reader/writer capable of recording information in the NFC tag 22. With such a configuration, the information on the area where the image is formed beforehand is recorded in the NFC tag 22 and this information is read in a next printing process. In this way, the print area of the medium is simply updated into a new print area.

Alternatively, information on an area where an image is formed beforehand in association with medium identification information (for example, a medium ID) for designating a medium is stored in a predetermined storage unit (a print area storage unit) such as the non-volatile RAM of the control unit 11, and this information is combined with the medium ID in a next printing process. Then, when the medium ID is accorded, the information is read. In this way, the print area of the medium is also simply updated into the new print area.

In the embodiment described above, the size of an external shape of the medium may be stored as information to be recorded in the NFC tag 22.

In the embodiment described above, as the print medium, the CD/DVD medium 20 has been exemplified. A medium on which an image can be formed by the printing apparatus 10 may be used as the print medium. For example, the print medium does not necessarily have the round hole 20c, but may have a triangular hole or a rectangular hole as well as having no hole. When the medium has no hole, the protrusion 30a of the CD tray 30 is not necessary and the medium is set to a predetermined placement location of the CD tray. In this case, the center of the protrusion 30a cannot be designated as the reference location of the medium. However, when the location where the medium is placed and a rotational angle of the medium are known, the reference location may be defined by any method. Moreover, the image formed by the printing apparatus 10 may contain texts or the like. The printing apparatus 10 may be configured as a printer which has a function of forming an image on at least the medium.

The technical spirit of the invention is understandable as aspects of the invention other than the printing apparatus 10 described above. For example, the invention is understandable as a control method of the printing apparatus 10 including steps corresponding to the units of the printing apparatus 10 described above. In addition, the invention is understandable as a control program of the printing apparatus 10 causing the control unit 11 (computer) to execute the functions corresponding to the units of the printing apparatus 10 described above. In addition, the invention is understandable only with the print medium (for example, the CD/DVD medium 20) set to the printing apparatus 10 described above.

The embodiment described above is just one example of the invention and the invention may be modified or improved in various forms on the basis of a person skilled in the art.

What is claimed is:

1. An image forming apparatus which forms an image on a medium by inputting the image, comprising:
a wireless IC tag reader which reads information recorded in a wireless IC tag, when the wireless IC tag in which information on a print area of the medium is recorded is provided in the medium;
an information acquiring unit which acquires the information from the wireless IC tag by using the wireless IC tag reader;
a tag actual location designating unit which designates an actual location of the wireless IC tag by using the wireless IC tag reader;
a reference location designating unit which designates a reference location of the medium;
an angle calculating unit which calculates a rotational angle used to set the designated actual location of the wireless IC tag to a predetermined location on the basis of the designated reference location of the medium; and
an image forming unit which forms the image in the print area of the medium by rotating the image by the calculated rotational angle.

2. The image forming apparatus according to claim 1, wherein the angle calculating unit converts the designated actual location of the wireless IC tag into a coordinate using the designated reference location as the origin, and calculates a rotational angle used to set the coordinate to a predetermined coordinate using the reference location of the medium as the origin and being based on the predetermined location.

3. The image forming apparatus according to claim 1, wherein the predetermined location is a predefined location where the wireless IC tag is attached to or embedded in the medium.

4. The image forming apparatus according to claim 1,
wherein information on an attachment location where the wireless IC tag is attached to or embedded in the medium is additionally recorded in the wireless IC tag, and
wherein the predetermined location is a coordinate using the reference location of the medium as the origin and being based on the attachment location.

5. The image forming apparatus according to claim 4, wherein the attachment location is present on one of coordinate axes in a rectangular coordinate system using the reference location of the medium as the origin.

6. The image forming apparatus according to claim 1,
wherein the wireless IC tag reader is equipped in a print head forming the image,
wherein the medium is set to a media tray which is moved in a sheet feeding direction perpendicular to a scanning direction of the print head, and
wherein the tag actual location designating unit designates the actual location of the wireless IC tag by sequentially moving the media tray whenever the print head performs scanning and scanning the wireless IC tag reader on the entire surface of the medium.

7. The image forming apparatus according to claim 1, further comprising a print area storage unit which stores an area where the image is formed beforehand.

8. The image forming apparatus according to claim 7,
wherein the wireless IC tag reader is a wireless IC tag reader/writer which also records information in the wireless IC tag, and
wherein the print area storage unit records information on the area where the image is formed beforehand in the wireless IC tag.

9. The image forming apparatus according to claim 7, wherein the print area storage unit stores the information on the area where the image is formed beforehand in association with medium identification information for designating the medium in a predetermined storage unit.

10. A control method of an image forming apparatus which forms an image on a medium by inputting the image, comprising:
acquiring information from a wireless IC tag by using a wireless IC tag reader, when the wireless IC tag in which information on a print area of the medium is recorded is provided in the medium and the wireless IC tag reader reading the information recorded in the wireless IC tag is equipped in the image forming apparatus;
designating an actual location of the wireless IC tag by using the wireless IC tag reader;
designating a reference location of the medium;
calculating a rotational angle used to set the designated actual location of the wireless IC tag to a predetermined location on the basis of the designated reference location of the medium; and
forming the image in the print area of the medium by rotating the image by the calculated rotational angle.

11. A program operating a computer as the image forming apparatus according to claim 1.

12. A print medium which is set to an image forming apparatus and in which an image input to the image forming apparatus is formed on a surface of the print medium, the print medium comprising:
a wireless IC tag in which information on a print area is recorded,
wherein the image forming apparatus acquires the information from the wireless IC tag by using the wireless IC tag reader, designates an actual location of the wireless IC tag by using the wireless IC tag reader, designates a reference location, calculates a rotational angle used to set the designated actual location of the wireless IC tag to a predetermined location on the basis of the designated reference location, and forms the image in the print area by rotating the image by the calculated rotation angle.
